(19) United States
(12) Patent Application Publication
(10) Pub. No.: US 2026/0036338 A1
(43) Pub. Date: Feb. 5, 2026

(54) LIGHT ENERGY HARVESTING SYSTEMS AND METHODS

(71) Applicant: Purdue Research Foundation, West Lafayette, IN (US)

(72) Inventors: Tillmann C. Kubis, West Lafayette, IN (US); Frederick C. Berry, Lafayette, IN (US)

(73) Assignee: Purdue Research Foundation, West Lafayette, IN (US)

(21) Appl. No.: 19/283,544

(22) Filed: Jul. 29, 2025

Related U.S. Application Data
(60) Provisional application No. 63/677,829, filed on Jul. 31, 2024.

(51) Int. Cl. F24S 23/00; F24S 20/20; F24S 23/30; F24S 23/71; F24S 30/45; F24S 50/20

(52) U.S. Cl. CPC F24S 23/10; F24S 20/20; F24S 23/31; F24S 23/71; F24S 30/45; F24S 50/20

(57) ABSTRACT

A light energy harvesting apparatus includes an optical element, at least one LED, and a power storage device. The optical element is configured to receive at least one incoming light beam and disperse the at least one incoming light beam into a light spectrum, the light spectrum being defined by a plurality of spectral light beams. Each LED of the at least one LEDs is positioned to receive one of the plurality of spectral light beams and output an electrical power signal therefrom.

### CROSS-REFERENCE TO RELATED APPLICATIONS

This application is related to and claims the priority benefit of U.S. Provisional Application No. 63/677,829, entitled “Light Energy Harvesting Systems and Methods” filed Jul. 31, 2024, and the benefit of U.S. Provisional Application No. 63/712,761, entitled “Flexible Nanoparticle Based Light Collection and Distribution Devices” filed Oct. 28, 2024, the contents each of which are hereby incorporated by reference in their entirety into the present disclosure.

### TECHNICAL FIELD

The present application relates to optical devices and systems, and specifically to optical devices selectively operable to harvest light energy using light emitting diodes (LEDs). More particularly, embodiments relate to spectral separation systems that optimize light-to-electrical energy conversion through wavelength-specific LED arrays.

### BACKGROUND

This section introduces aspects that may help facilitate a better understanding of the disclosure. Accordingly, these statements are to be read in this light and are not to be understood as admissions about what is or is not prior art.

The use of LEDs has become ubiquitous in numerous applications due to their energy efficiency, durability, and compact size. LEDs have primarily been employed for their ability to emit light by converting electrical energy into photons, enabling applications ranging from general lighting to display technologies. However, there is an increasing demand for energy-efficient devices that can harness ambient light and convert it into usable electrical energy. This demand has led to the development of LEDs and LED-based devices which can efficiently emit light and also harvest light energy.

### SUMMARY

Aspects of this disclosure describe a light energy harvesting apparatus. In some aspects, the apparatus can include an optical element, and at least one LED. The optical element can be configured to receive at least one incoming light beam and disperse the at least one incoming light beam into a light spectrum, the light spectrum being defined by a plurality of spectral light beams. Each LED of the at least one LEDs can be positioned to receive one of the plurality of spectral light beams and output an electrical power signal therefrom. The power storage device can be configured to receive and store each electrical power signal. In some embodiments, the apparatus can include one or more optical elements collectively configured to receive the at least one incoming light beam and collimate the at least one incoming light beam to provide to the optical element.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1A depicts an elevational view of one exemplary flexible nanoparticle-based optical fiber;

FIG. 2A depicts a cross-sectional view of the optical fiber of FIG. 1A, taken along cutting plane 1B-1B of FIG. 1A;

FIG. 2A depicts a first experimental representation of the light distribution of a first optical fiber, where the first optical fiber does not include nanoparticles;

FIG. 2B depicts a second experimental representation of the light distribution of a second optical fiber, where the second optical fiber includes nanoparticles, showing the light more evenly distributed along the second optical fiber in comparison to the light distributed from the first optical fiber of FIG. 2A;

FIG. 3 depicts a schematic view of a cladding-pumped double-clad fiber laser;

FIG. 4 depicts a schematic view of substrate including a plurality of optical fibers, the substrate operable to harvest light;

FIG. 5 depicts a schematic view of an alternative optical fiber which may be utilized with the substrate of FIG. 3;

FIG. 6 depicts a schematic view of a photo reactor device, showing the interior of the photo reactor device with the door removed;

FIG. 7 depicts a schematic view of a surface light emitting tube; and

FIG. 8 depicts a schematic view of one exemplary light energy harvesting device.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown, or the precise experimental arrangements used to arrive at the various graphical results shown in the drawings.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

### I. Overview

LEDs have a semiconductor p/n junction with a positive side and negative side between an electrical connector. Once a voltage is applied to the connectors, an electrical current is generated through the semiconductor which releases energy as photons. The photons that come out are of different wavelengths which give them different colors such as red, green, and blue. These wavelengths are typically somewhere between 400 nm long to 700 nm long with infrared, IR, at around 900 nm which is invisible to the naked eye but can be seen using certain devices (e.g., a cell phone camera). Near-infrared wavelengths extend from approximately 700 nm to 1400 nm and can be harvested using specialized LEDs or photodiodes designed for these longer wavelengths. Mid-infrared radiation from 1400 nm to 3000 nm represents additional harvestable energy in concentrated solar applications. Different combinations of materials allow LEDs to have different colors, usually with some combination of gallium, silicon, phosphorus, etc. Specific semiconductor compositions include gallium arsenide (GaAs) for infrared applications, gallium phosphide (GaP) for green and red wavelengths, indium gallium nitride (InGaN) for blue and white LEDs, and aluminum gallium arsenide (AlGaAs) for red and infrared applications. The bandgap energy of these materials determines the optimal wavelength for both emission and photovoltaic conversion.

While running a voltage through the LED will release energy as photons, the reverse is also true. Directing photons onto the semiconductor material (e.g., by shining a lamp on the LED, or in this case, using the sun), the semiconductor material generates power that can be used. The photovoltaic effect in LEDs operates through the same physical principles as conventional solar cells, but with several advantages when the incident light wavelength is closely matched to the LED's bandgap energy. Conversion efficiencies of 75% or higher can be achieved when the photon energy slightly exceeds the bandgap energy, compared to typical solar cell efficiencies of 15-20% across broad spectral ranges. As such, while LEDs are efficient converters of electrical energy into light, the same LEDs are efficient in converting light into electrical energy as well. The spectral selectivity of LEDs means that thermal losses are minimized when incident photon energies closely match the bandgap, allowing for much higher concentration ratios without thermal degradation compared to conventional photovoltaic systems.

Described herein are devices configured to selectively harvest or emit light energy according to ambient conditions and local control. However, it should be understood that the LEDs utilized in all embodiments are capable of emitting light powered by stored energy, thus each embodiment is theoretically capable of both harvesting and emitting light energy depending on the application requirements.

### II. Exemplary Devices for Selectively Harvesting and Emitting Light Energy

One challenge for both LED-based light harvesting and light emitting applications is that LEDs have only small surfaces over which they emit or absorb light. As described herein, methods to distribute light of LEDs can include emitting light from large one-dimensional (1D) areas or two-dimensional (2D) surfaces. The optical coupling between small LED active areas and large collection or emission surfaces operates through total internal reflection within waveguide structures, where light propagates by successive reflections at the core-cladding interface when the numerical aperture conditions are satisfied. For example, 1D areas may be illuminated by emitting light along the length or a portion of the length of one or more optical fibers. The light distribution mechanism relies on controlled scattering from nanostructures positioned at predetermined locations along the fiber, where each scattering event redirects a fraction of the guided light out of the fiber core at specific angles determined by the nanostructure size and refractive index contrast. As another example, 2D surfaces may be illuminated by emitting light from flexible coatings of surfaces that embed the 1D fibers, or by coating 2D surfaces with light-emitting nanostructures. When multiple fibers are woven into fabric-like structures, the overlapping emission patterns create uniform surface illumination through careful control of fiber spacing and individual fiber scattering profiles. The intensity distribution across the surface can be controlled by varying the density and size of scattering nanostructures along each fiber. Accordingly, light may be selectively spread from small LEDs to or from large surfaces.

It is an important insight that the challenge to produce or to harvest light can be separated into two steps: 1) funneling light from an impact area into a conversion area, or from a conversion area to an output area, and 2) converting light into electricity or converting electricity into light. State of the art solar cells do not separate those two steps. Similar is true for light sources, which are typically standardized in terms of output area. For customized applications, the funneling from emission surface of a light source to a designated output area requires light funneling with a customized waveguide. One example of a waveguide is an optical fiber. While cylindrical optical fibers are described in greater detail below and within the drawings, it should be understood that optical waveguides may be formed in many different shapes and sizes for varying applications while still utilizing the particular components and descriptions illustrated and described herein as they relate to optical fibers.

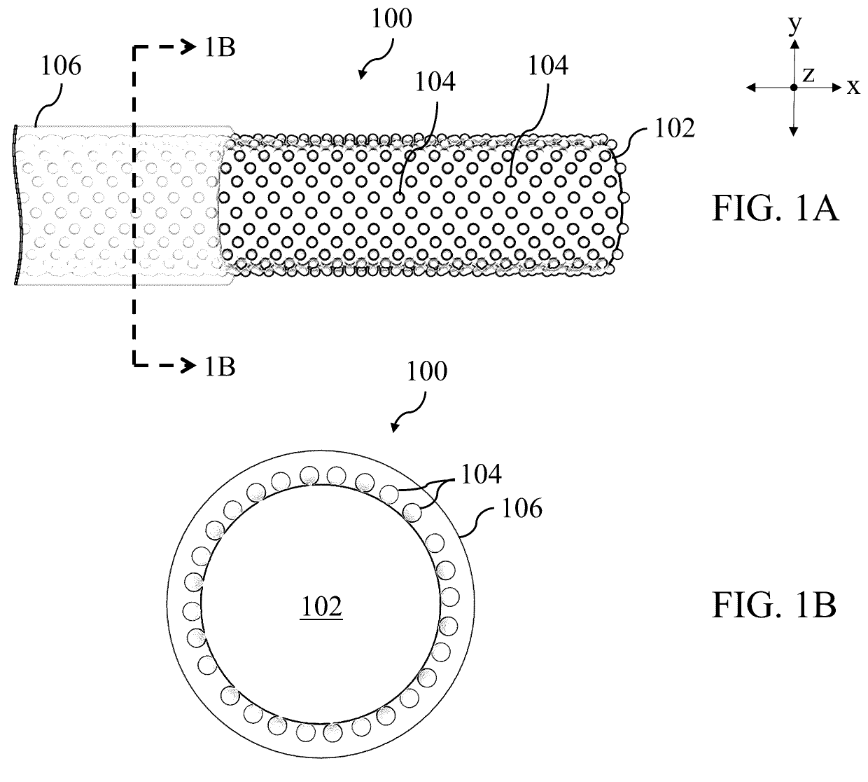

Shown in FIGS. 1A and 1B is one exemplary waveguide, formed as an optical fiber (100). Optical fiber (100) includes a core (102), a plurality of nanostructures (104) positioned on or embedded into the core (102), and a cladding (106) formed over the core (102) and nanostructures (104). The core (102) functions as the primary light-guiding region where total internal reflection occurs at the core-cladding interface, provided that light rays strike this interface at angles greater than the critical angle determined by the refractive indices of the core and cladding materials. Particularly, the core (102) may be shaped in generally cylindrically and elongated to form a fiber. The cylindrical geometry maintains circular symmetry of the propagating optical modes while the elongated structure enables light to travel over extended distances with minimal loss. Core diameters typically range from 50 micrometers to 1000 micrometers depending on whether single-mode or multimode propagation is desired, with single-mode operation generally requiring core diameters less than 10 micrometers for visible wavelengths. However, it should be understood the overall size and shape of the fibers may be outside of that range depending on the particular application, though without straying from the general principles as described herein.

The core (102) may be formed from PMMA, silicone elastomers, organic elastomers, transparent polymers, or other materials having similar properties related to flexibility, stretchability, and temperature tolerance.

The nanostructures (104) may be formed from solids (e.g., nanoparticles) or defects, such as aluminum oxide, gold, glass, sugar, diamond and cracks and defects at the surface of the core (102). The light scattering mechanism from these nanostructures operates through Mie scattering when the nanostructure diameter is comparable to the wavelength of light, or Rayleigh scattering when the diameter is much smaller than the wavelength. Mie scattering provides more directional scattering patterns that can be controlled by the nanostructure material properties and size distribution, while Rayleigh scattering produces more uniform omnidirectional emission. The nanostructures (104) are formed to provide scattering centers for the light in the core, the cladding, and the surroundings. The scattering efficiency depends on the refractive index contrast between the nanostructure material and the surrounding core material, with higher contrast providing stronger scattering per nanostructure. Gold nanoparticles provide particularly strong scattering due to plasmonic resonance effects, where the oscillating electric field of the light induces collective electron oscillations in the metal nanoparticles. The nanostructures (104) may be affixed to or embedded onto an exterior surface of the core (102). Accordingly, as the light traveling inside the optical fiber bounces on the internal walls of the core, these light-scattering nanostructures reflect some of the incident light outside the fiber, achieving uniform side emission. The uniformity of side emission is controlled by the longitudinal distribution density of nanostructures, where higher densities near the light input end compensate for the progressive depletion of guided light along the fiber length. This creates a tapered distribution where nanostructure density increases exponentially along the fiber to maintain constant emission intensity per unit length. In some embodiments, nanostructures (104) may each be sized from approximately 10 nanometers to 10 micrometers in diameter.

The cladding (106) may be formed from PMMA, silicone elastomers, organic elastomers, transparent polymers, or other materials having similar properties for performing the functions described below. The cladding (106) may encapsulate or at least partially insulate the core (102) and nanostructures (104) and provide mechanical stability to the nanostructures as well as a difference in the refractive index relative to the core (102) and the surroundings. In some embodiments, the optical fiber (100) does not include the cladding (106), or otherwise cladding (106) only covers a portion optical fiber (100) (e.g., a portion of the length in the x-direction).

These flexible and stretchable side-emitting optical fibers may in some embodiments be fabricated using elastomers having different indices of refraction: one elastomer for the core and a different elastomer for the cladding. In such an example, the index of refraction of the core elastomer can be 1.5, while the index of refraction of the cladding elastomer can be 1.4. The flexibility of optical fiber (100), particularly a plurality of optical fibers (100), allows economical fabrication of large area surfaces that can selectively be used to emit light or to absorb light and convert into electricity, or switch between both modii depending on one or more environmental factors (e.g., day and night modus of billboards), user-interactions, or defined schedules. As another example, the size, flexibility, and stretchability allow the inclusion of the LEDs into woven fabrics.

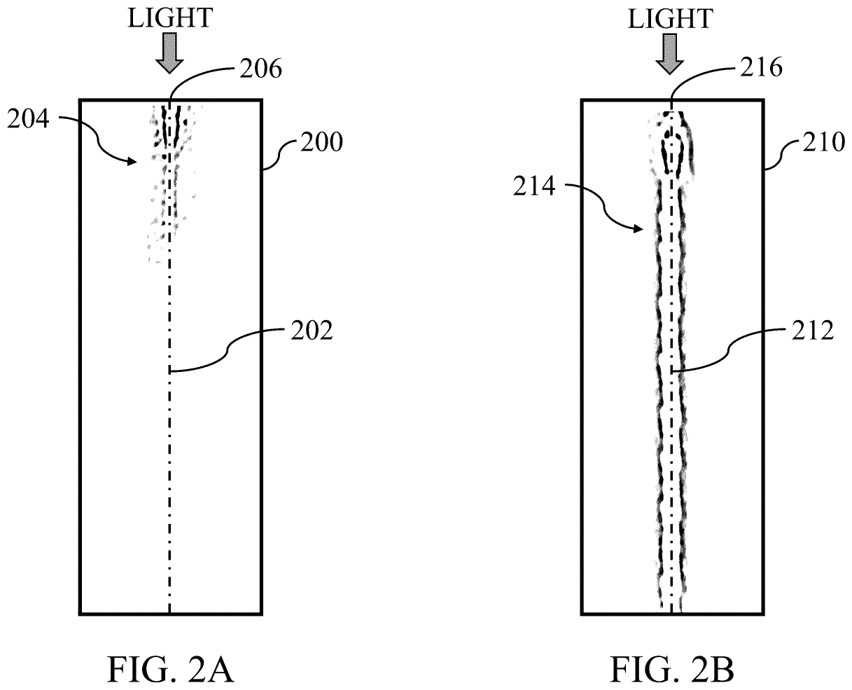

Shown in FIGS. 2A and 2B are exemplary experimental results (200, 210) of a flexible and stretchable optical fiber, one of which only emits at its tip (FIG. 2A), and a flexible and stretchable side-emitting optical fiber, such as optical fiber (100), described herein (FIG. 2B). Particularly, as shown in the results (200) of FIG. 2A, for a side-emitting optical fiber (illustrated by dashed line (202)) which does not include any light-scattering particles, such as nanostructures (104) of optical fiber (100), light entering an end facet (206) is predominantly distributed within a region (204) near the entry facet (206). In contrast, as shown in the results (210) of FIG. 2B, for a side-emitting optical fiber (illustrated by dashed line (212)) which does include light-scattering particles, such as nanostructures (104) of optical fiber (100), light entering an end facet (216) is relatively evenly distributed within a region (214) along the length of the optical fiber (212). As such, in one embodiment when optical fiber (212) (or a plurality of optical fibers (212) bundled or woven together) is coupled with UV light, they efficiently scatter the UV light across the length of optical fiber (212). Since UV light efficiently inhibits bacterial proliferation, a disinfection zone is created around the optical fiber. While some diffusive optical fibers are constructed having a glass core, optical fiber (212) may include a silicone core for UV applications and thus will not change colors when distributing sunlight or running UV-C light. At least for this reason, optical fiber (212) can be more effectively and more efficiently integrated into any surface, including laminates.

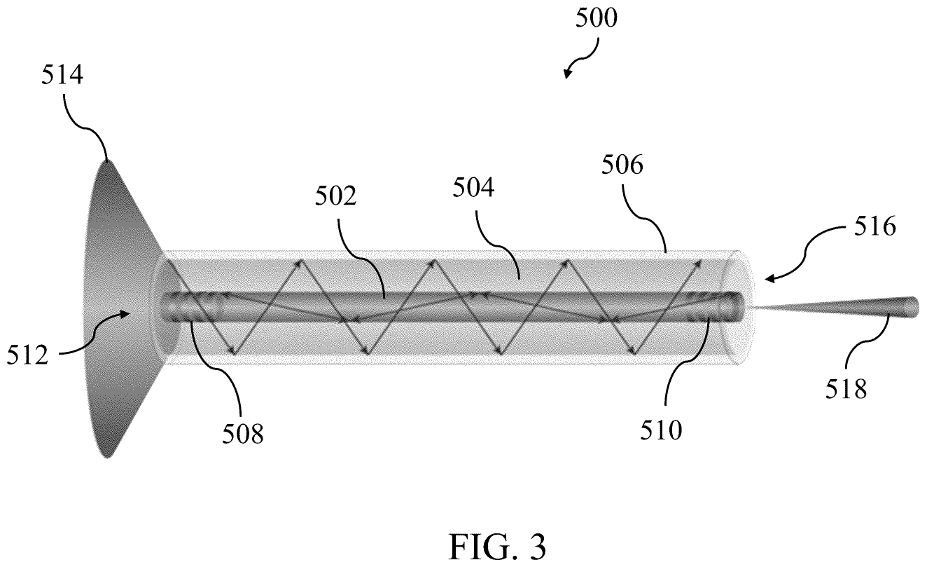

Shown in FIG. 3 is an exemplary cladding-pumped double-clad fiber laser (500) formed using the techniques described above with reference to optical fiber (100). The double-clad fiber laser configuration enables efficient coupling of high-power pump light through the large-area inner cladding while maintaining single-mode operation in the small-diameter doped core, achieving power scaling capabilities not possible with conventional single-clad fiber lasers. Particularly, a laser (500) may be formed by a doped core (502) (e.g., a signal waveguide), an inner cladding (504) (e.g., a pump waveguide), an outer cladding (506) (i.e., one which includes a lower refractive index), a first mirror (508) (e.g., a Fiber Bragg grating), a second mirror (510), which may be a partial mirror. The doped core (502) contains rare-earth ions such as ytterbium, erbium, or neodymium that provide optical gain through stimulated emission when pumped by absorbed light. The dopant concentration must be optimized to balance gain efficiency with nonlinear effects and excited-state absorption that can limit performance at high power levels.

The pump light propagation in the inner cladding (504) follows multimode propagation characteristics, where numerous propagation modes enable efficient collection of pump light from high-power diode sources with relatively large emission areas and high numerical apertures. The pump absorption occurs through evanescent field coupling between the pump modes in the inner cladding and the doped core, with absorption efficiency depending on the overlap integral between the pump mode intensity distribution and the doped region.

Further, the larger numerical aperture (512) can be configured to receive an incoming signal (514), which may be a low brightness, high power pump signal, and the smaller numerical aperture (516) can be configured to emit an output signal (518), which may be a high brightness, high power pump signal. With the flexibility of the coating and fibers, arbitrary geometries of the laser light emitting surface (516) are feasible. This additional design flexibility could be relevant for creating high temperatures in a focal point, for example, by creating a hollow sphere with its internal surface emitting laser light or for creating laser light emission over a large surface area. One particular application example is laser driven nuclear fusion. In other examples, EUV-surface areal lasers could be used for semiconductor device fabrication.

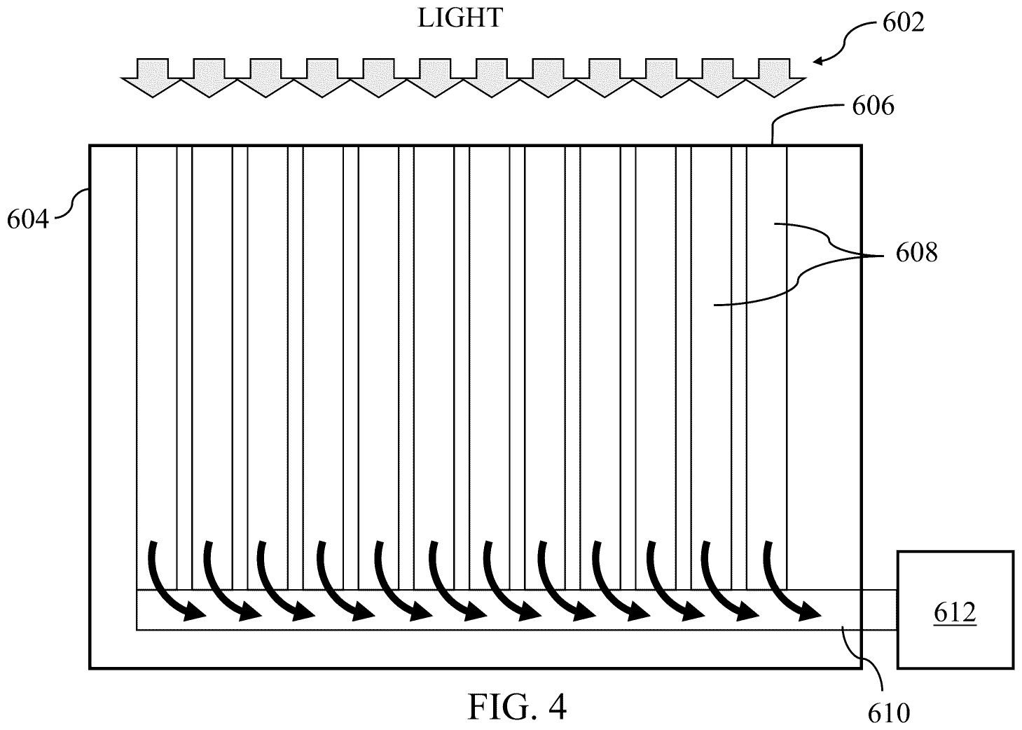

In the same configuration as is described above, coatings or surfaces including one or more optical fibers, configured similar to optical fiber (100), can selectively be used to harvest light over large areas in addition to distributing light. The bidirectional capability of optical fibers for both light collection and distribution operates through the principle of optical reciprocity, where the light paths for emission and collection are identical but traversed in opposite directions. This enables the same fiber infrastructure to function alternately as a collection system during peak sunlight hours and as a distribution system during evening illumination needs. As shown in FIG. 4, light (602) (e.g., sunlight or light from other light sources) that reaches the coated surfaces (604) can be directed through a facet (606) into each respective optical fiber (608) and directed to an optical channel (610) toward one or more LEDs (612) to be converted into electrical power. Covering large areas with such surfaces (604) for light harvesting becomes economical as only a small number of LEDs may be required to harvest light that is collected by larger areas. The light collection mechanism relies on the acceptance angle of the optical fiber, determined by its numerical aperture, which defines the cone of light that can be efficiently coupled into the fiber. For polymer optical fibers with numerical apertures of 0.3-0.5, acceptance half-angles of 17-30 degrees enable collection of both direct and diffuse solar radiation throughout much of the day.

The light concentration achievable through fiber-optic collection systems depends on the ratio of collection area to LED active area and the numerical aperture of the delivery system. Concentration ratios of 100:1 to 1000:1 are practically achievable, limited primarily by the numerical aperture of the delivery optics and the acceptance area of the LEDs. Higher concentration ratios enable the use of smaller, more efficient LEDs while reducing the cost per watt of conversion capacity.

In contrast, conventional solar cells only convert the light on the spot it was collected, which is a technological approach that scales poorly (see, for example, the thermal management of solar cells) and with high costs for that production and scaling. Conventional photovoltaic scaling limitations arise from several factors: thermal management becomes increasingly difficult as cell area increases due to resistive losses and current density limitations; manufacturing yields decrease for larger individual cells due to defect probability scaling; and the electrical interconnection complexity increases with array size, introducing additional resistance losses and reliability concerns. Semi-reflective coatings on the optical fibers or coating the fibers only partially with the nanostructures directs the absorption function on specific areas only, though improves the channeling effect with less losses. For instance, nanostructure coating on the side facet of the fiber that is exposed to the sun allows for efficient entry of light into the fiber. A semi-reflective coating on that same side prevents the light from escaping back towards the sun, whereas the pristine other fiber facets maintain a good light guide with no losses along the fiber.

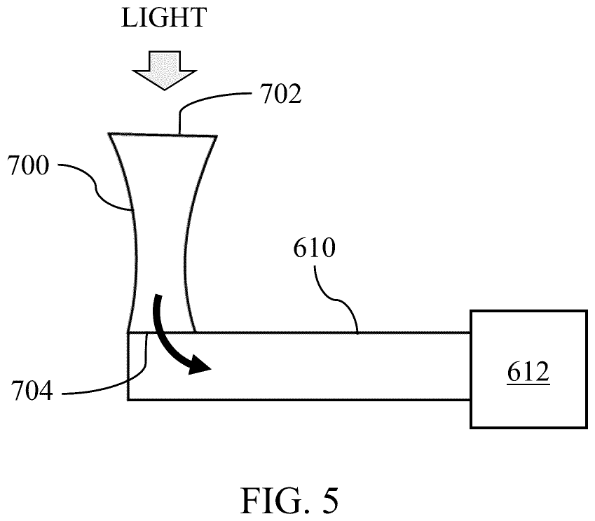

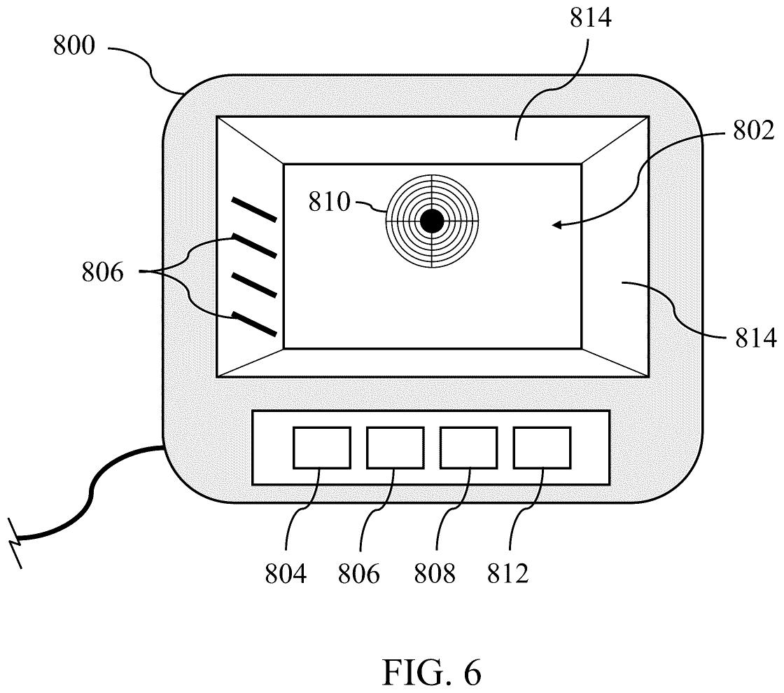

Shown in FIG. 5 is one exemplary alternative embodiment of an optical fiber (700) which performs the function of optical fiber (608) described above. Particularly, optical fiber (700) may be configured having a tapered body shape, such as by having a larger facet (702) for light collection than the facet (704) configured to direct light to the optical channel (610) toward LED (612). As such, light may more efficiently be both collected and channeled.

In accordance with the description above, optical fibers have been described which provide several advantages over prior art optical systems. For example, the described optical fibers are flexible and stretchable and configured for uniform side-emission, the optical fibers are compatible with both visible and UV light therefore allowing the user to display colors (e.g., for display or decoration) and UV light (e.g., for disinfection), the optical fibers are compatible with conventional LED strips and bundling of optical fibers, the optical fibers are compatible with laminating systems, and the optical fibers maintain a high degree of transparency, to name a few.

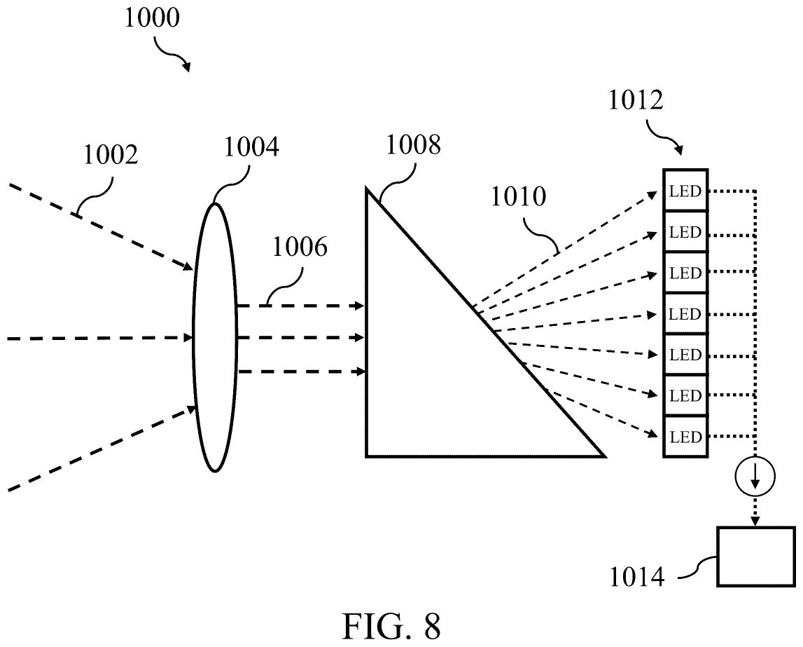

In one example application, as shown in FIG. 8, the optical fibers described above can be integrated into a photo reactor system (800) for conducting photochemical reactions under controlled light conditions. Photo reactor system (800) require precise control of light intensity, wavelength distribution, and spatial uniformity to achieve reproducible reaction kinetics and product yields. The optical fiber approach enables decoupling of the light source location from the reaction volume, allowing heat-generating lamp systems to be located remotely while delivering clean optical energy to the reaction zone. A temperature control system maintains reaction temperature within ±1° C. of setpoint values, as many photochemical reactions exhibit strong temperature dependence where rate constants can double for every 10° C. temperature increase. The thermal management must account for both heat generated by the photochemical process itself and any heating from absorbed light that does not contribute to the desired chemistry.

The photo reactor system (800) can include several components, such as a reaction vessel (802) to contain the sample, a light controller (804) to generate and/or control the necessary illumination to initiate the photochemical reaction within the reaction vessel (802), light distribution elements (806), (e.g., mirrors, lenses, optical fibers, etc.), and optionally various additional systems such as temperature controllers (806), stirring mechanisms/controllers (808), such as for a fan (810), and safety features (812). In such systems, the surface emitting optical fibers described above may be formed into discrete light distribution elements (806) positioned within the reaction vessel (802) to efficiently distribute light within the reaction vessel (802). In some embodiments, one or more of the interior surfaces (814) of the reaction vessel (802) may be coated in their entirety with the above-described surface emitting optical fibers. Namely, the surface(s) (814) may include a core material, nanostructures disposed on a surface of the core material, and a cladding material, such that the surface(s) (814) evenly distribute light within the reaction vessel (802).

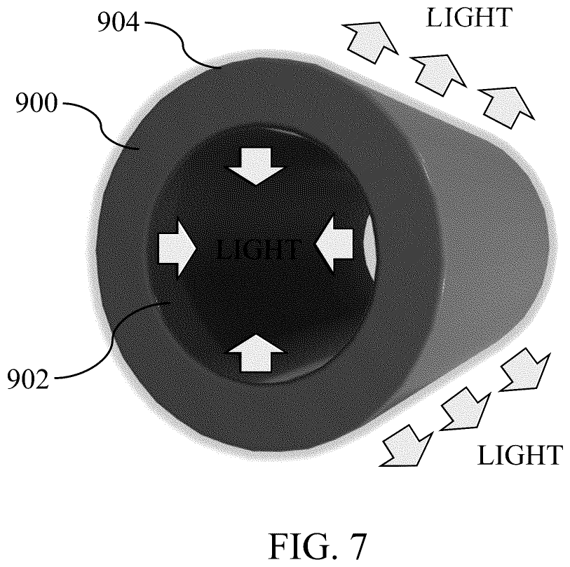

Shown in FIG. 7 is one exemplary embodiment of a water treatment conduit (900) configured to operate using one or more of the optical fibers described herein. Water treatment applications utilizing UV disinfection require precise dose delivery to achieve pathogen inactivation while minimizing energy consumption and infrastructure complexity. The optical fiber approach enables distributed UV delivery throughout the water volume, substantially improving dose uniformity compared to conventional UV lamp systems where shadowing and absorption create non-uniform treatment zones. The UV disinfection mechanism operates through direct photochemical damage to pathogen DNA and RNA, where UV-C radiation at 254 nm wavelength creates pyrimidine dimers that prevent cellular replication and ultimately cause organism death. The required UV dose for 99.9% pathogen kill rates varies from 10 mJ/cm² for bacteria to 100 mJ/cm² for viruses and cryptosporidium oocysts. The water treatment conduit (900) is configured to pass liquids therethrough the inner cavity while simultaneously treating, or disinfecting, the liquid using light, such as ultraviolet light. The light may be generated and passed through the core material of the conduit (900). Particularly, the inner surface (902) of the conduit (900) may include the core material, nanostructures disposed on a surface of the core material, and a cladding material, such that the surface (902) evenly distributes light within the cavity and toward the liquid. In some applications, the outer surface (904) may be similarly configured to emit the light from the surface (904) as well.

As such, the optical fibers described herein may provide benefits in several applications, such as disinfection of surfaces, for example, laminates, food packaging, packaging of germ-sensitive products, clothing, carpeting (e.g., to rid carpeting of dust mites), upholstery (e.g., car seats, aircraft seats, sofas, benches, etc.), bed linens, and bandages, to name only a few. The described optical fibers may be used for the prevention of fouling, such as biofouling or physisorption. The described optical fibers may be used for illumination of surfaces, such as large displays in the order of meters, traffic signs, street markings, 3D displays, illumination of surfaces of 3D objects (e.g., automobiles), active camouflage (e.g., radar or IR-stealth). The described optical fibers may further be used for illuminating fabrics, for example, clothing, solar sails (e.g., propulsion with light for space flight by collecting light from stars and emitting it into specific directions for steering and accelerating) or signaling flags. The described optical fibers for additional applications, such as self-cooling fabrics for channeling and emitting heat radiation, for example, passive cooling applications or water vapor condensation (e.g., “harvesting clouds”); fabric-based conversion of light into electric energy, for example, utilizing clothing as solar cells or providing large area solar cell coverage; light collection, for example, creating black bodies, thermal or optical insulation or natural light intensification (e.g., forming a “natural light laser”); the formation of light emitting and absorbing devices (LEADs), for example, billboards, street markings, or traffic signs; light sensors for amplifying the light collection area; frequency specific applications, such as by modifying design aspects (e.g., fiber diameter, nanostructure type, coating material, inks that are color selective, switchable inks of the optical fibers) to achieve select frequencies; modification of fiber lasers, such as introducing nanostructures or general geometries, such as hollow spheres for generating high temperatures. While several applications of the described optical fibers have been described above, it should be understood that the list is not exhaustive and additional applications have been contemplated.

### III Exemplary Devices for Efficient Light Energy Harvesting

Existing solar panels convert light into usable energy, but they reflect about 10% of the incoming light and they can only convert about 15% to 20% of that light into electricity. The other 80% to 94% of that energy is converted to heat. To that end, described in this section is a device designed to convey incoming light onto a power generating device such as a solar panel or, as specifically detailed herein, an LED array, to maximize light energy transmission using 3D printed materials. The approach fundamentally separates the light collection and concentration function from the photovoltaic conversion function, enabling independent optimization of each process. The light collection can be optimized for maximum throughput and concentration ratio, while the conversion elements can be optimized for peak efficiency at specific wavelengths without compromising collection area. More particularly, the advantageous optics device design directs light from the sun using a larger effective area onto an array of LEDs positioned in a complementary arrangement to efficiently harvest the light output from the optics device. The complementary arrangement ensures that each LED receives light within its optimal spectral response range, maximizing the photovoltaic conversion efficiency while minimizing thermal losses that degrade conventional solar cell performance.

In the field of optics, the physics of reflection and refraction are key concepts supporting many systems, such as long-distance communication fiber optics, to function. Reflection occurs according to the law of reflection where the angle of incidence equals the angle of reflection, both measured relative to the surface normal. This principle governs the operation of mirrors and reflective concentrator systems used for light collection and redirection. Any light, whether originating from the sun or from an LED, follows the rules of reflection and refraction. Reflection occurs when a wave, such as light or sound, bounces off a surface and changes direction while staying in the same medium. The angle at which the wave hits the surface (angle of incidence) equals the angle at which it bounces away (angle of reflection). Refraction is the bending of a wave as it passes from one medium to another with different densities, changing its speed. The change in direction depends on the angle of incidence and the indices of refraction of the two media, described by Snell's Law. Dispersion, the wavelength-dependent variation in refractive index, enables spectral separation where different wavelengths are refracted by different amounts when passing through the same optical element. This dispersion relationship typically follows the Cauchy equation or Sellmeier equation, allowing precise calculation of angular separation for different spectral components.

Shown in FIG. 8 is one example of a light harvesting device (1000) configured to receive incoming light beams (1002). The light harvesting device (1000) represents a complete spectral separation and conversion system designed to overcome the limitations of conventional broad-spectrum photovoltaic approaches. The system architecture separates light collection, spectral dispersion, and wavelength-specific conversion into distinct optimized subsystems. For example, the incoming light beams (1002) may be ambient beams from the sun or may be from any other light source. The incoming light beams (1002) typically represent solar radiation with a spectral distribution approximating a 5800K blackbody, containing photon energies from approximately 1.1 eV (1100 nm) to 3.1 eV (400 nm) across the useful solar spectrum. The intensity distribution varies throughout the day and with atmospheric conditions, requiring the system to operate efficiently across a range of input intensities from 100 W/m² under cloudy conditions to 1000 W/m² under direct sunlight. The incoming light beams (1002) are first passed through a collimating lens (1004) or lens system (which may include mirrors, prisms, to achieve collinear light beams). The collimating lens (1004) serves the function of transforming the divergent or convergent light rays into parallel rays, ensuring that subsequent optical elements receive light at predictable angles for optimal performance. The collimation process is essential for maintaining the precision of spectral separation in downstream optical elements.

The collimating lens (1004) may comprise various optical configurations optimized for different performance requirements and cost constraints. In one embodiment, the collimating lens (1004) consists of a single plano-convex lens fabricated from optical glass such as BK7 or crown glass, with a focal length ranging from 50 mm to 500 mm depending on the desired system aperture and concentration ratio. The lens diameter typically ranges from 25 mm for portable applications to 300 mm for stationary installations, with larger diameters enabling higher total light collection but requiring more precise mechanical mounting and alignment systems.

Alternative embodiments of the collimating lens (1004) include compound lens systems that reduce spherical and chromatic aberrations through the use of multiple lens elements with different glass types and curvatures. A doublet configuration combining crown and flint glass elements can reduce chromatic aberration to less than 0.1% across the visible spectrum, ensuring that all wavelengths focus to the same plane for optimal coupling to the spectral separation element. For large-scale applications, Fresnel lens implementations provide equivalent optical performance while reducing weight and material costs, with Fresnel lenses achieving concentration ratios exceeding 1000:1 in practical systems.

The mounting and adjustment mechanisms for the collimating lens (1004) must accommodate thermal expansion and mechanical tolerances while maintaining optical alignment within ±0.1 degrees for optimal system performance. Adjustment mechanisms may include threaded barrel mounts for coarse positioning and piezoelectric actuators for fine adjustment and active tracking compensation. The lens mount design must also account for environmental protection, including sealing against moisture and dust ingress that could degrade optical surfaces over extended operation periods.

Once the light beams are collimated, the collimated beams (1006) are passed through an optical element (1008) configured to reflect and/refract the collimated beams (1006) as they pass through and exit the opposing end. The collimated beams (1006) maintain parallel ray geometry with angular deviations typically less than ±2 milliradians from the optical axis, enabling predictable interaction with the dispersive optical element (1008). The beam diameter and intensity distribution of the collimated beams (1006) must be matched to the acceptance aperture and damage threshold of the optical element (1008).

The optical element (1008) functions as the spectral separation component that disperses the collimated white light into constituent wavelength bands for wavelength-specific LED conversion. The selection and design of this element determines the spectral resolution, angular separation, and overall system efficiency. The optical element (1008) must achieve sufficient angular dispersion to enable physical separation of different wavelength bands while maintaining high transmission efficiency across the entire solar spectrum.

While one example of an optical element (1008) is illustrated, shown as a 90-degree prism, it should be understood that the shape and size of the optical element (1008) may be varied depending on the application without deviating from the key function of splitting the beam into multiple individual wavelengths (i.e., colors). The 90-degree prism configuration utilizes the principle of angular dispersion where the deviation angle for different wavelengths varies according to the material's dispersion characteristics. For a 90-degree prism fabricated from BK7 glass, the angular separation between red (700 nm) and blue (400 nm) light is approximately 1.2 degrees, providing sufficient separation for LED placement while maintaining compact system geometry.

Alternative embodiments of the optical element (1008) include transmission diffraction gratings with groove densities ranging from 300 to 1800 lines per millimeter, providing significantly higher angular dispersion than prism-based systems. A 600 line/mm grating can achieve angular separations of 15-25 degrees between red and blue wavelengths, enabling larger physical separation distances for LED placement but requiring larger system envelopes. The grating efficiency must be optimized for the intended wavelength range, with blazed gratings achieving peak efficiencies exceeding 85% when properly designed for the operating wavelength.

Grism configurations, combining a transmission grating with a prism, offer advantages of both approaches by providing high dispersion with reduced system size and the ability to achieve straight-through geometry where the central wavelength emerges parallel to the input beam. This configuration simplifies system alignment and reduces the complexity of LED positioning while maintaining high spectral resolution. The grism design requires careful optimization of the prism angle and grating parameters to achieve the desired dispersion characteristics while maximizing transmission efficiency.

For high-concentration applications, volume holographic gratings (VHGs) provide extremely high spectral selectivity with narrow reflection bands that can isolate specific wavelength ranges with bandwidths less than 10 nm. VHG-based systems can achieve wavelength selectivity that closely matches individual LED spectral response curves, maximizing conversion efficiency but requiring multiple VHG elements or complex optical switching systems to address the full solar spectrum.

The mounting and alignment system for the optical element (1008) must maintain angular positioning accuracy within ±0.05 degrees to preserve spectral purity and LED coupling efficiency. Temperature compensation mechanisms account for thermal expansion effects that can shift spectral positions by several nanometers per degree Celsius temperature change. Active alignment systems using piezoelectric positioning stages can provide real-time correction for thermal drift and mechanical settling effects.

As shown, the individual light beams (1010) exiting the optical element (1008) are each directed onto a specially tailored LED that is configured to efficiently capture that wavelength of light. The individual light beams (1010) represent spectrally resolved portions of the original solar spectrum, with each beam containing photons within a specific wavelength band optimized for the spectral response of its corresponding LED. The beam geometry and intensity distribution of each individual light beam (1010) must be carefully controlled to achieve uniform illumination of the LED active area while avoiding damage from excessive intensity concentrations.

The spatial and angular characteristics of the individual light beams (1010) depend on the dispersion properties of the optical element (1008) and the collimation quality of the input beam. For prism-based systems, each spectral beam maintains the original beam diameter but is deflected at a wavelength-dependent angle, requiring LED positioning along an arc centered on the prism. For grating-based systems, the beams are deflected linearly with wavelength, enabling LED placement along a straight line for simplified mechanical construction.

The intensity distribution within each individual light beam (1010) should achieve uniformity within ±10% across the LED active area to prevent localized heating and ensure uniform current generation. Beam shaping optics may be incorporated between the optical element (1008) and the LEDs to transform the circular beam profile into shapes that better match rectangular LED geometries, improving coupling efficiency and reducing spillover losses.

For instance, the collimated light beam (1006) may be split into various colors: red (approximately 620-750 nm wavelength), orange (approximately 590-620 nm wavelength), yellow (approximately 570-590 nm wavelength), green (approximately 495-570 nm wavelength), blue (approximately 450-495 nm wavelength), indigo (approximately 425-450 nm wavelength), violet (approximately 380-425 nm wavelength). These wavelength bands represent a practical compromise between spectral resolution and system complexity, with each band containing sufficient spectral width to capture meaningful solar energy while maintaining compatibility with commercially available LED technologies. The specific wavelength boundaries can be adjusted based on LED availability and spectral response characteristics to optimize overall system efficiency.

The spectral band selection criteria consider both the solar irradiance distribution and LED quantum efficiency characteristics. The solar spectrum peaks at approximately 500 nm (green), suggesting emphasis on efficient conversion in this region, while LED technologies demonstrate varying efficiency across different wavelength ranges. Red and infrared LEDs typically achieve the highest quantum efficiencies (>80%), while blue and UV LEDs show lower but improving efficiencies (40-60%). The system design balances these factors to optimize overall energy conversion.

Alternative spectral band configurations may include narrower bands (25-50 nm width) for higher conversion efficiency at the cost of increased system complexity, or broader bands (100-150 nm width) for simplified systems with reduced component count. Adaptive band selection systems can dynamically adjust spectral boundaries based on real-time measurements of solar spectrum and LED performance to maximize instantaneous conversion efficiency.

Thus, an array (1012) of seven LEDs is shown, one each to capture the beams listed above. However, a larger or fewer number of LEDs may be used. The array (1012) represents the photovoltaic conversion subsystem where optical energy is converted to electrical energy through the photoelectric effect in semiconductor devices optimized for specific wavelength ranges. The seven-LED configuration provides a practical balance between conversion efficiency and system complexity, though alternative configurations with 3-20 LEDs can be implemented depending on performance requirements and cost constraints.

Each LED within the array (1012) is selected based on its spectral response characteristics to maximize quantum efficiency for its assigned wavelength band. For the red band (620-750 nm), aluminum gallium arsenide (AlGaAs) LEDs provide quantum efficiencies exceeding 80% when operated in reverse bias photodiode mode. Green band LEDs (495-570 nm) utilize gallium phosphide (GaP) or indium gallium phosphide (InGaP) semiconductors achieving efficiencies of 60-70%. Blue band LEDs (450-495 nm) employ indium gallium nitride (InGaN) technology with efficiencies of 40-60% that continue to improve with advancing material science.

The physical arrangement of LEDs within the array (1012) follows the geometric constraints imposed by the optical element (1008) dispersion characteristics. For prism-based systems, LEDs are positioned along an arc with angular spacing corresponding to the spectral dispersion, typically requiring mounting surfaces angled 15-45 degrees relative to the optical axis. Linear grating systems enable LED mounting along a straight line, simplifying mechanical construction and electrical interconnection but potentially requiring larger system envelopes to accommodate the linear geometry.

The LED mounting system must provide precise positioning (±0.1 mm) to ensure optimal coupling with the incident light beams while providing thermal management capabilities to remove waste heat. Thermal interface materials with conductivities exceeding 2 W/m−K transfer heat from the LED junction to heat sinks or thermal spreading plates. For high-concentration systems, active cooling through thermoelectric coolers or liquid cooling systems may be necessary to maintain LED junction temperatures below 85° C. for optimal efficiency and reliability.

Alternative LED array configurations include stacked arrangements where multiple LEDs address the same spectral band to increase power handling capability, and segmented arrays where individual LEDs are subdivided into smaller elements for improved current density distribution. Concentrator LED systems specifically designed for high optical flux densities can handle concentration ratios exceeding 1000 suns while maintaining conversion efficiencies above 70%.

Each LED from the array of LEDs (1012) is configured to combine its respective electrical output for transfer away from the array of LEDs (1012), such as to a battery (1014) or other electrical energy storage device electrically coupled therewith the LEDs. The electrical interconnection system must efficiently collect and combine the power generated by individual LEDs while providing maximum power point tracking (MPPT) capability to optimize energy extraction under varying illumination conditions. The electrical configuration affects both the power output characteristics and the system reliability.

The battery (1014) or electrical energy storage device serves as the energy buffer and power management system, storing converted solar energy for use during periods of low illumination and providing power conditioning for downstream electrical loads. The selection of storage technology depends on application requirements including energy density, power density, cycle life, and environmental operating conditions.

Lithium-ion battery systems provide high energy density (150-250 Wh/kg) and good cycle life (>2000 cycles) for portable and mobile applications. The battery management system must monitor individual cell voltages and temperatures to prevent overcharging and thermal runaway conditions. For stationary applications, alternative technologies such as lead-acid batteries offer lower cost per kilowatt-hour stored energy, while emerging technologies such as lithium iron phosphate provide improved safety characteristics and longer cycle life.

The electrical interconnection between the LED array (1012) and battery (1014) incorporates power conditioning electronics including DC-DC converters for voltage regulation and MPPT controllers for optimal energy extraction. Individual LED outputs may be connected in series to increase voltage levels, in parallel to increase current capacity, or in series-parallel combinations to achieve desired voltage and current characteristics while providing redundancy against individual LED failures.

Advanced power management systems include individual LED monitoring and control capabilities, enabling dynamic reconfiguration of the electrical connections based on real-time performance measurements. This capability allows the system to isolate underperforming or failed LEDs while maintaining operation of the remaining array elements, improving overall system reliability and availability.

The electrical power generated by the LED array (1012) can be utilized in multiple ways beyond storage in electrical energy storage devices. In some embodiments, the electrical power is used instantaneously to supply real-time electrical loads without requiring energy storage systems. Direct power utilization eliminates storage losses and provides immediate energy conversion for applications such as water pumping, ventilation systems, or electrical equipment that operate during daylight hours when solar energy is available.

Alternative energy storage approaches convert the electrical power into non-electrical forms of stored energy. In some embodiments, the electrical power drives electrolysis systems that split water into hydrogen and oxygen gases, storing energy in chemical form as hydrogen fuel. The hydrogen can be subsequently converted back to electrical power through fuel cells or combusted directly for thermal energy applications. Electrolytic hydrogen generation provides long-term energy storage capabilities with minimal self-discharge losses compared to battery systems.

In some embodiments, the electrical power operates electrochemical synthesis systems that produce chemical fuels such as synthetic hydrocarbons, ammonia, or other energy-dense chemical compounds. These chemical energy storage systems enable transportation and long-term storage of harvested solar energy in forms compatible with existing fuel infrastructure and industrial processes.

Mechanical energy storage systems represent another alternative for power utilization. In some embodiments, the electrical power drives compressor systems that store energy as compressed air in tanks or underground caverns. The compressed air can be subsequently expanded through pneumatic motors or generators to recover electrical power when needed. Similarly, the electrical power can operate pumping systems that store energy as gravitational potential energy in elevated water reservoirs, with energy recovery through hydroelectric generators.

Thermal energy storage systems convert electrical power into stored thermal energy through resistive heating, heat pumps, or thermochemical processes. In some embodiments, the electrical power charges thermal storage materials such as molten salts, phase change materials, or thermochemical storage compounds that release stored energy as heat for space heating, industrial processes, or thermal-to-electric conversion systems.

The selection of power utilization and storage approaches depends on application requirements including energy density, power density, storage duration, conversion efficiency, and economic considerations. Hybrid systems may combine multiple storage approaches, such as batteries for short-term storage and hydrogen generation for long-term storage, to optimize performance across varying operational requirements and time scales.

Power management systems coordinate between immediate power utilization and various storage options based on real-time energy demand, storage capacity, and economic optimization algorithms. Smart control systems can prioritize direct power utilization when electrical loads are present, switch to preferred storage modes when excess power is available, and manage power distribution between multiple storage systems to maximize overall system efficiency and economic value.

Alternative electrical energy storage approaches include supercapacitor systems for high power density applications requiring rapid charge and discharge capabilities, and hybrid systems combining batteries and supercapacitors to optimize both energy and power characteristics. Grid-tied systems may eliminate on-board storage entirely, feeding converted power directly into electrical distribution systems through appropriate inverter and power conditioning equipment.

In some embodiments, the array of LEDs may be organized underneath a light focusing, bundling, and splitting apparatus (e.g., a waveguide) such that each LED is positioned where light of its ideal color gets projected onto it. The precise positioning system ensures that each LED receives optical energy within its optimal spectral response range, maximizing photovoltaic conversion efficiency while minimizing thermal losses from photons with excess energy. The positioning accuracy requirements typically demand mechanical tolerances within ±0.1 mm to maintain optimal coupling efficiency as misalignment can reduce power output by 10-20% per millimeter of displacement.

The light focusing, bundling, and splitting apparatus may incorporate secondary concentration optics between the primary dispersion element and the LED array to increase optical flux density and improve coupling efficiency. Secondary concentrators such as compound parabolic concentrators (CPCs) or Winston cones can increase concentration ratios by an additional factor of 2-10 times while maintaining acceptance angles compatible with the dispersed beam geometry. These secondary optics must be designed to preserve spectral purity while providing uniform illumination across each LED active area.

Alternative focusing approaches include micro-lens arrays positioned directly above each LED to collect light over larger areas and focus it onto the small LED active regions. The micro-lens arrays can be fabricated using precision molding or photolithographic techniques to achieve lens diameters of 1-5 mm with focal lengths optimized for the LED spacing and incident beam characteristics. Anti-reflection coatings applied to the micro-lens surfaces can improve transmission efficiency by 2-4% per surface, providing meaningful improvements in overall system efficiency.

If the input of the optical element (1008) is collinear light, the device (1000) may need to continuously reorient itself towards that light source (e.g., such as in the case of the moving sun). The sun-tracking requirement arises from the directional nature of the collimated optical system, where peak efficiency occurs only when the optical axis is aligned within ±2 degrees of the solar direction. The solar position changes continuously throughout the day and seasonally throughout the year, requiring either manual adjustment or automated tracking systems to maintain optimal performance.

Automated sun-tracking systems for the device (1000) may employ dual-axis tracking mechanisms that provide azimuth and elevation control to maintain solar alignment throughout daily and seasonal cycles. The tracking accuracy requirements demand positioning precision within ±0.1 degrees to maintain coupling efficiency above 95% of the optimal value. Mechanical tracking systems typically employ stepper motors or servo motors with gear reduction ratios of 100:1 to 1000:1 to achieve the required angular resolution while providing sufficient torque to overcome wind loading and mechanical friction.

Solar position sensing for tracking control can be accomplished through several approaches. Photovoltaic sensor arrays positioned around the perimeter of the device provide electrical signals proportional to solar direction, enabling feedback control for tracking motors. Alternatively, astronomical calculations based on GPS coordinates and real-time clock data can provide open-loop tracking control with accuracy sufficient for most applications. Hybrid systems combine both approaches, using astronomical calculations for coarse positioning and sensor feedback for fine adjustment and cloud tracking capability.

The mechanical tracking structure must withstand environmental loads including wind, seismic activity, and thermal cycling while maintaining optical alignment accuracy. The structural design typically employs lightweight aluminum or steel frame construction with appropriate stiffness-to-weight ratios. Wind loading analysis considers both steady-state wind forces and dynamic gust loading, with typical design requirements for survival in 120 mph winds and operational capability in winds up to 35 mph.

Power requirements for tracking systems typically range from 5-50 watts depending on system size and environmental conditions, representing 1-5% of the total energy generated by typical installations. Energy-efficient tracking algorithms minimize unnecessary movement by implementing deadband controls and predictive positioning based on solar ephemeris calculations. Sleep modes during nighttime hours and adverse weather conditions further reduce parasitic power consumption.

If the light source is a diffuse source, the apparatus may need to bundle the light into collinear waves before funneling into color-splitting optics, such as is shown in FIG. 10. Diffuse light conditions, including overcast skies and indirect solar radiation, present challenges for spectral separation systems optimized for collimated input beams. The bundling process must collect light from a wide range of incident angles and redirect it into a collimated beam suitable for efficient spectral dispersion.

Light bundling for diffuse sources can be accomplished through compound parabolic concentrators (CPCs) or other non-imaging concentrators that accept light over wide angular ranges (±30 to ±60 degrees) and concentrate it into narrower output angles suitable for the spectral separation optics. The concentration ratio achievable with CPC systems is limited by the thermodynamic brightness theorem but can typically achieve 5:1 to 20:1 concentration while maintaining high collection efficiency for diffuse sources.

Alternative approaches for diffuse light collection include integrating sphere systems that collect and homogenize light from multiple directions before coupling into the spectral separation system. The integrating sphere approach provides excellent angular uniformity but may suffer from multiple reflection losses that reduce overall system efficiency. Hybrid systems combining directional tracking for direct solar radiation with diffuse collection capability for cloudy conditions can optimize performance across varying weather conditions.

Adaptive optics systems can dynamically adjust the collimation and concentration characteristics based on real-time measurements of incident light conditions. Liquid crystal or deformable mirror systems enable electronic control of optical properties without mechanical movement, providing rapid response to changing illumination conditions. These systems add complexity and cost but can significantly improve energy capture under variable weather conditions.

The overall system efficiency of the device (1000) depends on the cascade efficiency of all optical and electrical components. Typical component efficiencies include: collimating optics (90-95%), spectral separation element (85-92%), LED photovoltaic conversion (60-80% depending on wavelength), and power conditioning electronics (90-95%). The overall system efficiency can therefore range from 42% to 65% under optimal conditions, representing a significant improvement over conventional broad-spectrum photovoltaic systems operating at 15-20% efficiency.

Performance optimization strategies include real-time monitoring of individual LED outputs to detect degradation or misalignment, automated cleaning systems for optical surfaces exposed to environmental contamination, and adaptive control algorithms that optimize electrical load matching for maximum power extraction. Predictive maintenance systems can schedule cleaning and alignment procedures based on performance trends and environmental conditions to maintain peak efficiency over multi-year operating periods.

Environmental protection systems safeguard sensitive optical and electronic components from moisture, dust, temperature extremes, and UV degradation. Sealed optical assemblies with desiccant moisture control maintain internal humidity below 40% relative humidity to prevent condensation on optical surfaces. Thermal management systems maintain component temperatures within specified operating ranges through passive heat sinking, forced air cooling, or liquid cooling systems as appropriate for the installation environment and power levels.

The modular design approach enables scalable installations where multiple device (1000) units can be arranged in arrays for increased power generation capacity. Inter-unit spacing must account for mutual shading effects while optimizing land use efficiency for utility-scale installations. Electrical interconnection between multiple units enables power aggregation and provides redundancy against individual unit failures, improving overall system reliability and availability.

Economic analysis of the device (1000) must consider both capital costs and operational advantages compared to conventional photovoltaic systems. Higher conversion efficiency reduces the land area and installation infrastructure required for a given power output, while the separation of collection and conversion functions may enable longer component lifetimes and simplified maintenance procedures. The spectral separation approach may command premium pricing in applications where high efficiency and compact form factor provide significant value.

In some embodiments, the light energy harvesting device (1000) may be integrated with optical fiber distribution systems to enable bidirectional operation. The same LED array (1012) that converts spectral light beams to electrical energy can operate in reverse to emit light for distribution through optical fiber networks during periods when illumination is needed rather than energy harvesting.

The bidirectional capability operates through the principle of optical reciprocity, where the LEDs function as photodiodes during harvesting mode and as light emitters during distribution mode. Control systems automatically switch between modes based on ambient light conditions, energy storage levels, or user requirements. During daylight hours, the system harvests solar energy through the spectral separation process, while during nighttime or low-light conditions, the same LEDs can emit light that is distributed through optical fibers to provide illumination.

In some embodiments, the optical fiber networks collect ambient light from large surface areas and channel it through optical pathways to the LED array (1012) for concentrated conversion. This creates a hierarchical collection system where distributed fiber networks across building surfaces, vehicle exteriors, or textile materials feed collected light to the centralized spectral separation device (1000). The fiber collection approach enables scaling the collection area independently from the conversion components.

The wavelength-specific optimization of the LED array (1012) provides advantages in both operating directions. LEDs selected for optimal photovoltaic conversion efficiency at specific wavelengths also demonstrate optimal emission efficiency at those same wavelengths when operating in emission mode. This dual optimization maximizes both energy harvest efficiency and light distribution efficiency using the same semiconductor devices.

Applications benefiting from bidirectional operation include billboard systems that harvest solar energy during daylight hours and provide advertising illumination during nighttime operation, architectural lighting systems integrated into building surfaces that collect ambient light and redistribute it for interior illumination, and emergency lighting systems that maintain charge through ambient light collection while providing illumination during power outages. The bidirectional approach enables self-sustaining optical systems that manage both energy generation and light distribution functions.

In some embodiments, the device (1000) may be combined with side-emitting optical fibers that distribute light uniformly across large surfaces while simultaneously collecting ambient light for energy conversion. The fibers incorporate light-scattering nanostructures that enable controlled light emission during distribution mode and efficient light collection during harvesting mode, providing dual functionality within the same optical infrastructure.

### IV. Performance Monitoring and Control Systems

Real-time performance monitoring systems track the output of individual LEDs within the array (1012) to detect degradation, misalignment, or component failures. Optical power meters integrated into the system measure total incident solar radiation and compare it to electrical power output to calculate instantaneous system efficiency. Performance data logging enables predictive maintenance scheduling and system optimization over multi-year operating periods.

Automated cleaning systems address optical surface contamination that can reduce system efficiency by 10-30% in dusty environments. The cleaning mechanisms may include periodic water spray systems, mechanical wipers for the collimating lens (1004), or electrostatic dust removal systems that require minimal water consumption in arid climates.

Adaptive control algorithms optimize system performance under varying environmental conditions by adjusting tracking parameters, electrical load matching, and component operating points. Machine learning algorithms can optimize performance based on historical weather patterns and system performance data, predicting optimal operating strategies for different seasonal and diurnal conditions.

Reference systems that may be used herein can refer generally to various directions (for example, upper, lower, forward and rearward), which are merely offered to assist the reader in understanding the various embodiments of the disclosure and are not to be interpreted as limiting. Other reference systems may be used to describe various embodiments, such as those where directions are referenced to the portions of the device, for example, toward or away from a particular element, or in relations to the structure generally (for example, inwardly or outwardly).

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

I/We claim:

1. A light energy harvesting apparatus, comprising:
(a) an optical element configured to receive at least one incoming light beam and disperse the at least one incoming light beam into a light spectrum, wherein the light spectrum is defined by a plurality of spectral light beams wherein the plurality of spectral light beams comprises different wavelength; and
(b) at least one LED, wherein each LED of the at least one LEDs is positioned to receive one of the plurality of spectral light beams and output an electrical power signal therefrom.

2. The light energy harvesting apparatus of claim 1, comprising one or more optical elements collectively configured to receive the at least one incoming light beam and collimate the at least one incoming light beam to provide to the optical element.

3. The apparatus of claim 2, wherein the one or more optical elements comprise a collimating lens.

4. The apparatus of claim 3, wherein the collimating lens comprises a Fresnel lens.

5. The apparatus of claim 3, wherein the collimating lens comprises a compound lens system.

6. The apparatus of claim 2, wherein the one or more optical elements comprise a parabolic reflector.

7. The apparatus of claim 1, wherein the optical element comprises a prism.

8. The apparatus of claim 7, wherein the prism comprises a dispersive prism having an apex angle between 30 degrees and 90 degrees.

9. The apparatus of claim 1, wherein the optical element comprises a transmission diffraction grating.

10. The apparatus of claim 9, wherein the transmission diffraction grating has groove densities between 300-1800 lines per millimeter.

11. The apparatus of claim 1, wherein the optical element comprises a grism combining refractive and diffractive elements.

12. The apparatus of claim 1, wherein each LED is selected to have peak photoresponse wavelengths that correspond to the spectral distribution created by the optical element.

13. The apparatus of claim 12, wherein each LED is optimized for conversion efficiency within a wavelength band of approximately 50-100 nanometers width.

14. The apparatus of claim 1, wherein the at least one LED comprises semiconductor materials selected from gallium arsenide, gallium phosphide, indium gallium nitride, and aluminum gallium arsenide.

15. The apparatus of claim 1, further comprising secondary concentration optics positioned between the optical element and the at least one LED to increase optical flux density.

16. A light energy harvesting system, comprising: (a) the apparatus of claim 1; and (b) a sun-tracking mechanism configured to continuously reorient the apparatus towards a moving light source.

17. The system of claim 16, wherein the sun-tracking mechanism comprises dual-axis tracking providing azimuth and elevation control.

18. The system of claim 16, further comprising power conditioning electronics including converters and controllers electrically coupled to the at least one LED.

19. A method of harvesting light energy, comprising: (a) receiving incoming light beams with a collimating optical element; (b) dispersing collimated light beams into a plurality of spectral light beams using an optical element; and (c) converting optical energy in each spectral light beam into electrical energy using LEDs positioned to receive respective spectral light beams.

20. The method of claim 19, further comprising tracking solar position throughout daily and seasonal cycles to maintain optimal alignment.
